(19) United States
(12) Patent Application Publication
(10) Pub. No.: US 2006/0135120 A1
(43) Pub. Date: Jun. 22, 2006

(54) Method and system for awarding points to a mobile device subscriber based on usage time while at a predetermined location

(76) Inventor: George Likourezos, St. James, NY (US)

Correspondence Address: George Likourezos, 261 Washington Avenue, St. James, NY, 11780, US

(21) Appl. No.: 11/303,174

(22) Filed: Dec. 17, 2005

Related U.S. Application Data
(60) Provisional application No. 60/637,396, filed on Dec. 17, 2004.

(51) Int. Cl. H04Q 7/20

(52) U.S. Cl. 455/406; 455/456.1

(57) ABSTRACT

A method and system are disclosed for enabling a cell phone service provider or other type of service provider to retain subscribers and attract new subscribers, as well as existing subscribers from other service providers, by providing an incentive to subscribers for selecting its service. The incentive includes awarding the subscribers frequent flyer mileage points and/or other types of points based on cell phone usage time and/or other mobile device usage time while at a particular, predetermined location, such as onboard a particular commercial carrier. A method and system are also disclosed for providing an incentive to mobile device subscribers for selecting a predetermined location from a plurality of predetermined locations for mobile device usage time.

### PRIORITY

The present application claims priority to a provisional application filed on Dec. 17, 2004 titled “METHOD AND SYSTEM FOR PROVIDING AN INCENTIVE TO A CELL PHONE SUBSCRIBER FOR SELECTING ONE CELL PHONE SERVICE PROVIDER OVER ANOTHER” and assigned United States Provisional Application Ser. No. 60/637,396; the entire contents of which are incorporated herein by reference.

### TECHNICAL FIELD

The method and system of the present disclosure are directed to providing an incentive to a mobile device subscriber to select a mobile device service provider by awarding points to the mobile device subscriber based on mobile device usage time (i.e., air time) while at a predetermined location, such as onboard a commercial carrier. Hence, the method and system of the present disclosure further provides an incentive to the mobile device subscriber to select a predetermined location from a plurality of predetermined locations for mobile device usage time after having selected the mobile device service provider.

### BACKGROUND

Cell phone service providers and other types of mobile device service providers, such as Internet service providers, satellite radio service providers, and wireless email service providers, in continuous competition to obtain a greater market share of their respective industry. For example, cell phone service providers are in competition to attract new cell phone subscribers or existing cell phone subscribers from other service providers, while retaining their existing cell phone subscribers. Accordingly novel methods and systems are often sought and/or designed by cell phone service providers (and other service providers) for staying competitive by attracting new cell phone subscribers and causing existing cell phone subscribers to switch to them from other service providers.

For example, one method and system known in the prior art entails tracking the number of unused cell phone minutes for a particular cell phone subscriber during a particular time period, e.g., one month, and rolling over the unused cell phone minutes to a subsequent time period, e.g., the subsequent month. Accordingly, the cell phone subscriber is provided an incentive to stay with the cell phone service provider or to register as a new cell phone subscriber with the cell phone service provider providing this incentive, because as a cell phone subscriber with this cell phone service provider, the cell phone subscriber does not “lose” or pay for minutes which he did not use.

Another method and system for attracting new subscribers and retaining existing subscribers is described by U.S. Patent Publication No. 2004/0198380. This document describes a mobile telecommunication system which determines whether or not a mobile station or device is present at a predetermined geographical location. If yes, the system effects a differentiation between the overall charge for the call and a net charge to a subscriber of the mobile station, at the expense of a third party associated with the predetermined geographical location, such as a supermarket. Thus, the third party, that does business on commercial premises is enabled to provide an incentive for consumers to enter the premises, while at the same time the cell phone service provider provides an incentive to the subscriber of not having to pay for the entire charge of the call made from the predetermined geographical location.

Other prior art methods for attracting new subscribers and retaining existing subscribers include determining the geographic location of the subscriber using GPS or other positioning system, determining at least one business establishment, such as a coffee shop, in proximity to the geographic location, and transmitting to a subscriber's mobile device, such as a cell phone, a coupon which can be redeemed at the at least one business establishment.

### SUMMARY

The present disclosure provides a method and system for enabling a cell phone service provider or other type of service provider to retain subscribers and attract new subscribers, as well as existing subscribers from other service providers, by providing an incentive to subscribers for selecting its service. The incentive includes awarding the subscribers frequent flyer mileage points and/or other types of points based on cell phone usage time and/or other mobile device usage time (e.g., satellite radio usage time, Internet access usage time, wireless email usage time and messaging usage time) while at a predetermined location, such as onboard a particular commercial carrier traveling from a first geographical location to a second geographical location. The present disclosure therefore also provides a method and system for providing an incentive to mobile device subscribers for selecting a predetermined location from a plurality of predetermined locations for usage time.

As an example, the method and system of the present disclosure can be implemented by a cell phone service provider for attracting and retaining cell phone service subscribers by tracking cell phone usage time on a particular commercial airline and awarding the cell phone service subscribers with frequent flyer mileage points offered by the commercial airline or other types of points according to the amount of cell phone usage time while being transported on a commercial aircraft owned and/or operated by the particular commercial airline.

A method in a wireless communication system providing communication services to a plurality of subscribers in accordance with the present disclosure includes determining whether a mobile device subscriber is at a predetermined location; determining amount of mobile device usage time by the mobile device subscriber of a mobile device while at the predetermined location; and awarding points to the mobile device subscriber based at least on the amount of mobile device usage time of the mobile device while at the predetermined location.

A wireless communication network system in accordance with the present disclosure includes a database configured to store at least one point account; a controller operatively coupled to the database, the controller comprising a memory and a processor operatively coupled to the memory, the controller being programmed to determine usage of air time for communication services by a subscriber at predetermined locations; the controller being programmed to award a number of points to the subscriber based on the usage of air time at the predetermined locations; and the controller being programmed to store the number of points awarded to the subscriber in a point account associated with the subscriber.

A method in a wireless communication system providing communication services to a plurality of subscribers in accordance with the present disclosure includes providing an incentive to each of the plurality of subscribes based on mobile device usage time while at one of a plurality of predetermined locations; determining whether a mobile device subscriber is at the one of the plurality of predetermined locations; determining amount of mobile device usage time by the mobile device subscriber of a mobile device while at the one of the plurality of predetermined locations; determining a number points to award to the mobile device subscriber based on mobile device usage time at the one of the plurality of predetermined locations, wherein a different number of points are determined for identical mobile device usage times between at least two of the plurality of predetermined locations; and awarding the number of points computed to the mobile device subscriber.

### BRIEF DESCRIPTION OF THE DRAWINGS

Various embodiments of the present disclosure will be described herein below with reference to the figures wherein:

FIG. 1 is an illustration of an exemplary communication system in which the present technology may be applied;

FIG. 2A is an exemplary look-up table stored in memory of the communication system shown by FIG. 1 indicating the amount of cell phone usage time for a plurality of subscribes and the amount of points awarded to each subscriber; and

FIG. 2B is an exemplary look-up table stored in memory of the communication system shown by FIG. 1 indicating the amount of cell phone usage time and Internet usage time for a plurality of subscribers and the amount of points awarded to each subscriber.

### DETAILED DESCRIPTION

Embodiments of the present disclosure will be described herein below with reference to the accompanying drawings. In the following description, well-known functions or constructions are not described in detail to avoid obscuring the present disclosure in unnecessary detail.

The system and method of the present disclosure enable a mobile device service provider to attract new subscribers, as well as existing subscribers from other service providers, by awarding the subscribers with frequent flyer mileage points and/or other types of points based on mobile device usage time (e.g., cell phone usage time, satellite radio usage time, Internet access usage time, wireless email usage time, and messaging usage time (such as multimedia messaging, instant messaging, short messaging)) while at predetermined locations, such as onboard a particular commercial carrier for being transported from a first geographical location to a second geographical location.

The present disclosure therefore also provides a method and system for providing an incentive to mobile device subscribers for selecting the particular commercial carrier for being transported from the first geographical location to the second geographical location. As an example, the method and system of the present disclosure can be implemented by a cell phone service provider for attracting and retaining cell phone service subscribers by tracking cell phone usage time on a particular commercial airline and awarding the cell phone service subscribers with frequent flyer mileage points offered by the commercial airline or other types of points according to the amount of cell phone usage time used while being transported on a commercial aircraft owned and/or operated by the particular commercial airline.

As used throughout herein, the term “usage time” refers to air time. That is, the time the mobile device subscriber uses his mobile device for receiving and/or transmitting communication signals from and to another location via his mobile device, such as to talk to another person; access the Internet; transmit/receive text messages; listen to a satellite radio channel; and wirelessly access an e-mail account to read received e-mail messages and transmit e-mail messages.

As used herein and in the claims, the word “subscriber” is defined as an individual who subscribes to a service provided by a service provider for a periodic fee, such as cell phone service, Internet access service, wireless email service, and satellite radio transmission service, as well as to an individual who prepays for a service provided by the service provider.

The frequent-flyer mileage points or other types of points awarded can be redeemed by the subscribers for at least one of a product and service, e.g., airline tickets, airline seating upgrades, car rental discounts and other travel-related services, or for redeeming to enter in periodic giveaways, contests and/or sweepstakes, where the points are determined in accordance with a mathematical formula, e.g., one point for every five cell phone minutes of usage time while on a commercial carrier; and awarding the mobile device service subscriber with free subscriber minutes (e.g., free cell phone service) in accordance with a mathematical formula, e.g., one cell phone minute for every five cell phone minutes of usage time while on a commercial carrier. With respect to periodic giveaways, contests and sweepstakes, it is contemplated that the mobile device subscriber elects how many mileage points or other points to redeem for entering the periodic giveaways, contests and sweepstakes; where the more points redeemed, the subscriber has a greater chance of winning.

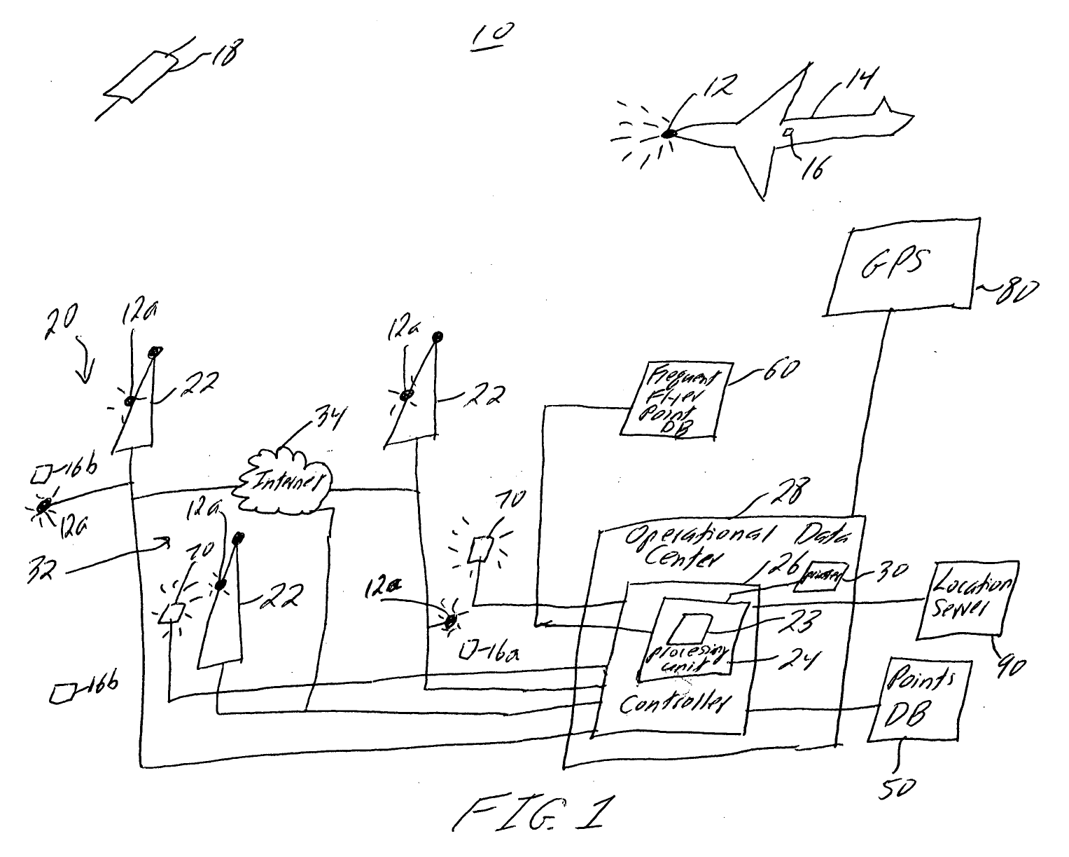

The present technology will now be described with reference to cell phone usage time, however, other types of mobile device usage time are contemplated as mentioned above. With reference to FIG. 1, there is shown an exemplary communication system in which the present technology may be applied. The system is designated generally by reference numeral 10 and includes an onboard pico cell 12 or other routing computing device on a commercial aircraft 14 which acts like a small cellular tower or signal router for managing separate wireless signals transmitted from an onboard cell phone 16 and other electronic devices. The signals are beamed from the pico cell 12 to a satellite 18 for distribution to ground cellular networks 20. Alternatively, the signals are beamed from the commercial aircraft 14 to ground towers 22 of the ground cellular networks 20.

A set of programmable instructions are stored within a memory 23 of at least one processing unit 24, such as a processor, within a central computer or controller 26 of an operational data center 28 operated by a cell phone service provider or other service provider. It is contemplated that the set of programmable instructions can be stored elsewhere within the system 10 and executed by a processor other than a processor of the controller 26. It is further contemplated that the set of programmable instructions can be packaged as a computer program and stored on one or more CD-ROMS, DVDs, and other storage media.

The set of programmable instructions stored within the memory 23 of the at least one processing unit 24 are used to program the at least one processing unit 24 for performing the functions necessary for performing the method of the present disclosure. That is, determining an identification code corresponding to the cell phone originating/receiving the cell phone call; determining whether the identified cell phone is located on the commercial aircraft 14 by determining the cell phone call is routed via the onboard pico cell 12 or other routing computing device; tracking the cell phone usage time of a cell phone subscriber corresponding to the identified cell phone while the subscriber is being transported by the commercial aircraft from a first geographical location to a second geographical location; determining based on the tracked cell phone usage time over a particular time period (e.g., one month) the amount of frequent flyer mileage points or other points to award to the cell phone subscriber corresponding to the identified cell phone; and storing the points awarded to the subscriber within a data structure of the system.

The second determining step includes analyzing signals transmitted by the onboard pico cell 12 or other routing computing device as to whether they contain a unique, identification data string which was appended to the signals by the pico cell 12 or other routing computing device. If the signals contain the data string, then it is determined that the signals were transmitted by an onboard pico cell or other routing computing device and that the cell phone subscriber is on the commercial aircraft. It is contemplated that the identification data string identifies the airline operator, flight number, originating location, destination location, and other information relating to the flight.

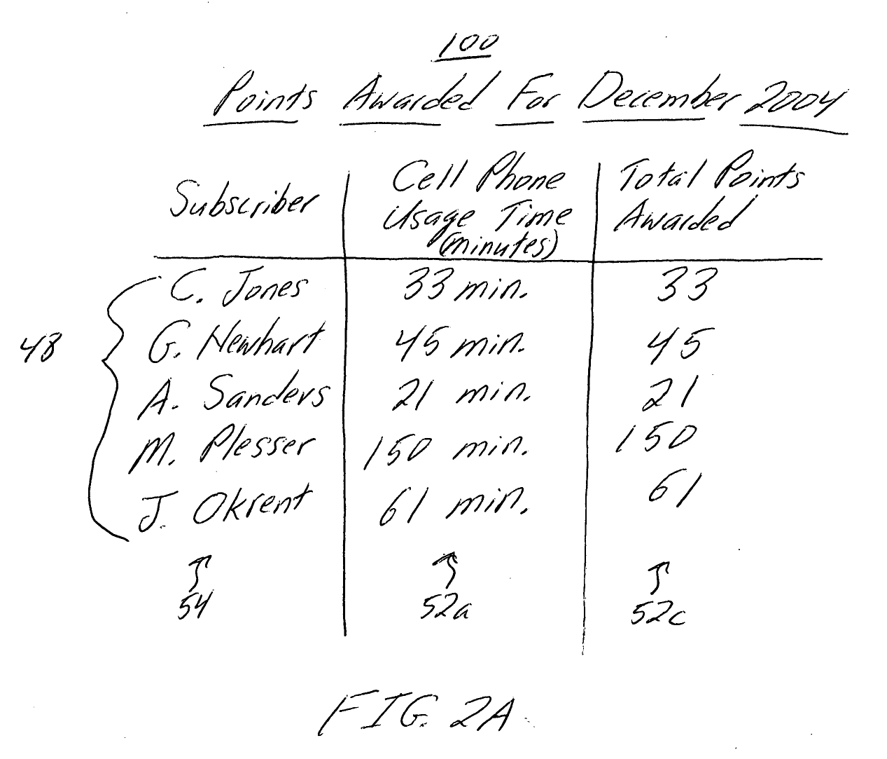

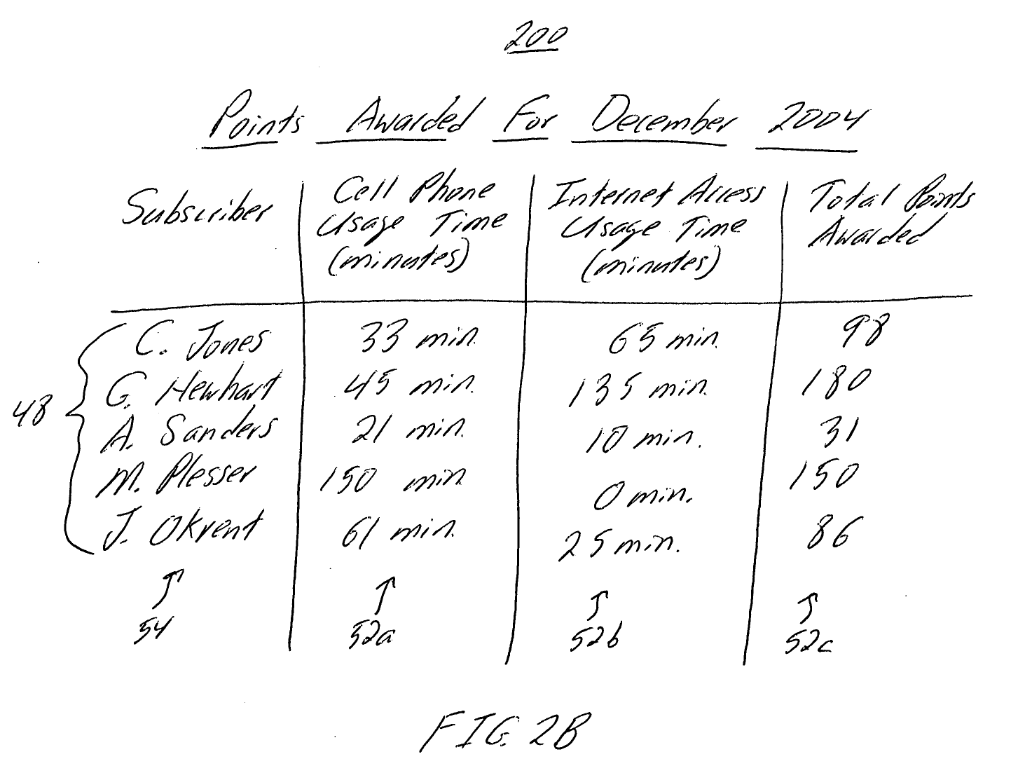

The points awarded to the cell phone subscriber are saved within point accounts 48 (see FIGS. 2A and 2B) stored in the form of a look-up table or other data structure within a points database 50 of system 10. The point accounts 48 stored in the form of one or more look-up tables provide the amount of points 52a (cell phone points), 52b (Internet access points), 52c (total points) awarded for each cell phone and cell phone/Internet subscriber 54 as respectively shown by the exemplary look-up tables of FIGS. 2A and 2B and further described below. Even though FIG. 2B illustrates two types of usage time (i.e., cell phone and Internet access usage times), the look-up tables can be configured for storing two or more types of usage time.

With reference to FIG. 2A, there is shown an exemplary look-up table designated by reference numeral 100 correlating the cell phone usage time of a plurality of subscribers while on commercial aircraft during one month (December 2004) with the amount of points (e.g., frequent-flyer mileage points and/or other points) awarded to each cell phone subscriber based on the amount of cell phone usage time while on commercial aircraft. As evident from FIG. 2A, in this exemplary illustration, the cell phone subscribers received one point for every one minute of cell phone usage time during the month. However, in accordance with the present disclosure different mathematical formulas can be used to determine the number of points awarded to each subscriber based on different types of information as discussed below.

The amount of frequent-flyer mileage points and/or other points awarded to the cell phone subscriber can then be communicated from the at least one processing unit 24 to a printer 30 of the operational data center 28 for printing the amount of frequent-flyer mileage points and/or other points awarded to the cell phone subscriber (including previously awarded points) on a cell phone bill to be mailed to the cell phone subscriber by the cell phone service provider.

The amount of frequent-flyer mileage points and/or other points awarded to the cell phone subscriber can also be communicated from the at least one processing unit 24 via the Internet or other network to the cell phone subscriber by the at least one processing unit 24 by transmitting in real-time, periodically, etc. an e-mail to the cell phone subscriber, a text message, etc. indicating the amount of frequent-flyer mileage points and/or other points awarded to the cell phone subscriber. In the case of frequent flyer mileage points being awarded to the cell phone subscriber, the controller 26 is programmed to communicate these points to a frequent flyer point database 60 storing the cell phone subscriber's frequent flyer mileage point account for being added to points already stored in the point account.

With reference to FIG. 2B, there is shown another exemplary look-up table designated by reference numeral 200 correlating the cell phone usage time and Internet access time of a plurality of cell phone/Internet access subscribers while on commercial aircraft during one month (December 2004) with the amount of points (e.g., frequent-flyer mileage points and/or other points) awarded to each cell phone/Internet subscriber based on the amount of cell phone usage time and Internet access time while on commercial aircraft. As evident from FIG. 2B, in this exemplary illustration, the cell phone/Internet access subscribers receive one point for every one minute of cell phone usage time and Internet usage time. However, in accordance with the present disclosure different mathematical formulas can be used to determine the number of points awarded to each subscriber based on different types of information as discussed below.

In the case of wireless Internet signals being transmitted from laptops or other electronic devices onboard commercial aircraft, the system of the present disclosure beams the signals from the onboard pico cell 12 or other routing computing device to the satellite 18 for distribution to ground communication networks 20. Alternatively, the signals are beamed from the commercial aircraft 14 to ground towers 22 of the ground communication networks 20 for subsequent distribution to ground networks 32 operatively connected to the Internet 34.

In a similar manner as described above for cell phone usage time, the at least one processing unit 24 determines an identification code corresponding to a device accessing the Internet 34 via an Internet connection; determines whether the identified device is located on a commercial aircraft by determining the Internet connection is routed via the onboard pico cell 12 or other routing computing device; tracks the wireless Internet usage time of the Internet subscriber corresponding to the identified device while on the commercial aircraft; determines based on the tracked Internet usage time over a particular time period (e.g., one month) the amount of frequent flyer mileage points and other points to award to the wireless Internet subscriber corresponding to the identified device; and stores the points awarded to the subscriber within a data structure of the system.

The second determining step includes analyzing signals transmitted by the onboard pico cell 12 or other routing computing device as to whether they contain an unique, identification data string which was appended to the signals by the pico cell 12 or other routing computing device. If the signals contain the data string, then it is determined that the signals were transmitted by an onboard pico cell or other routing computing device and that the wireless Internet subscriber is on the commercial aircraft. It is contemplated that the identification data string identifies the airline operator, flight number, originating location, destination location, and other information relating to the flight.

The amount of frequent-flyer mileage points and/or other points awarded to the wireless Internet subscriber can then be communicated from the at least one processing unit 24 to the printer 30 of the operational data center 28 for printing the amount of frequent-flyer mileage points and/or other points awarded to the cell phone subscriber (including previously awarded points) on an Internet access bill to be mailed to the wireless Internet subscriber by the wireless Internet service provider.

The amount of frequent-flyer mileage points and/or other points awarded to the wireless Internet subscriber can also be communicated from the at least one processing unit 24 via the Internet or other network to the wireless Internet subscriber by the at least one processing unit 24 by transmitting in real-time, periodically, etc. an e-mail to the wireless Internet subscriber, a text message, etc. indicating the amount of frequent-flyer mileage points and/or other points awarded to the wireless Internet subscriber. In the case of frequent flyer mileage points being awarded to the wireless Internet subscriber, the controller 26 is programmed to communicate these points to the database 60 storing the wireless Internet subscriber's frequent flyer mileage point account for being added to points already stored in the point account.

The technology disclosed by the present disclosure enables cell phone service providers and other service providers to attract subscribers from other service providers, while retaining existing subscribers. For example, one class of people the method and system of the present disclosure attracts and retains is frequent travelers who desire to place cell phone calls (wirelessly access the Internet, wireless receive/transmit email messages; and listen to satellite radio channels) using their cell phones while on a commercial aircraft and be provided with frequent flyer mileage points or other types of points for their cell phone usage time redeemable for at least one of a service and product, as well as for entering giveaways, contests and sweepstakes.

As such, the present disclosure also provides a first business method wherein a service provider, such as Verizon Wireless, and/or operator of the system 10, and a commercial entity, such as American Airlines, Inc., enter into a business relationship. The business relationship can provide that the service provider and/or operator of the system 10 are paid a fee by the commercial carrier for the operator of the system 10 to only award frequent flyer mileage points or other types of points for mobile device usage time by the service provider's subscribers while being transported by commercial aircraft operated and/or owned by the commercial carrier. Accordingly, the commercial carrier can advertise that subscribers of the service provider who use usage time while being transported by one of the carrier's aircraft will be awarded frequent flyer mileage points or other types of points. This provides an incentive to the service provider's subscribers to book flights with the commercial carrier.

The frequent flyer mileage points or other types of points can also vary based on different types of information as mentioned above, such as based on at least one of travel-related information corresponding to the carrier, mobile device subscriber-related information, and communication-related information. The travel-related information is selected from the group consisting of: information relating to the first geographical location; information relating to the second geographical location; time of departure; time of arrival, whether destination is an international destination; whether majority of travel is during a particular time period; whether time of departure was delayed for more than a predetermined amount of time; whether non-stop to the destination; and whether a meal is served during duration of trip.

The mobile device subscriber-related information is selected from the group consisting of: travel status of the subscriber (e.g., first class, economy and coach); number of passengers traveling with the subscriber; period of time subscriber is a customer of at least the service provider and carrier's owner and/or operator; and occupation of the subscriber.

The communication-related information is selected from the group consisting of: time of day of the communication service; length of time of the communication service; and type of communication service (email, Internet access, satellite radio reception, etc.).

Even though the method and system of the present disclosure is described herein with reference to FIG. 1 in the context of the subscriber being transported by a commercial aircraft, the method and system of the present disclosure also apply to the subscriber being transported by other commercial carriers, such as trains, ships, buses, trucks and automobiles. A commercial carrier is defined as a company owning and/or operating transport vehicles for transporting passengers.

The controller 26 of system 10 can be programmed for awarding frequent flyer mileage points or other types of points to commercial carrier passengers for usage time using fixed communication devices, such as onboard telephones on a commercial aircraft and fixed, Internet access computing devices on a cruise ship.

The method and system of the present disclosure also provides for programming the controller 26 to award points to the mobile device subscriber based on usage time at other predetermined locations of the mobile device subscriber besides commercial carriers, such as a particular venue, such as an airport terminal, mall, stadium, concert hall, office building, and business establishment, thereby providing an incentive to the mobile device subscriber to go to these venues and communicate via his mobile device while at these venues. A terrestrial pico cell 12a or other routing computing device of network 20 is programmed to generate and transmit a unique, identification data string along with the communication signals transmitted by the mobile device, such as terrestrial (not onboard an aircraft) cell phone 16b, in order for the controller 26 to analyze the data string and be able to determine the venue the mobile device is located at. The unique, identification data string is indicative of the venue.

According to the present disclosure, the location of the subscriber can also be determined using other means besides identification, data strings. The system 10 includes a global positioning system (GPS) 80 of which the satellite 18 may be a part of. The global positioning system 80 determines the origin of a communication signal transmitted by the mobile device, such as cell phone 16 onboard aircraft 14. The system 10 can also include other locating/positioning systems known in the art (e.g., a system which uses cell towers to triangulate the cell phone signal, thereby determining the user's location).

The global positioning system 80 or other locating/positioning system is in operative communication with the operational data center 28 for relaying the position of the mobile device to the controller 26. Locating/positioning systems which can be incorporated within the system 10 of the present disclosure are disclosed in U.S. Pat. Nos. 6,823,257 and 6,901,264, and U.S. Patent Publication No. 2004/0203924 A1; the entire contents of which are incorporated herein by reference.

The controller 26 is programmed to determine whether the position of the mobile device as communicated by the global positioning system 80 (or other locating/positioning system) is at one of a plurality of predetermined locations for which points are to be awarded for the usage time. The controller 26 is programmed to access a location server 90 storing location information corresponding to predetermined locations for which points are to be awarded for usage time at these locations. If the position relayed by the global positioning system 80 (or other locating/positioning system) is part of the location information stored by the location server 90, then the controller 26 determines that points are to be awarded for the usage time. If the position relayed by the global positioning system 80 (or other locating/positioning system) is not part of the location information stored by the location server 90, then the controller 26 determines that points are not to be awarded for the usage time.

The location server 90 also stores a mathematical formula for each predetermined location to be used for computing the number of points to award for each time period of usage time at the corresponding predetermined location. The mathematical formula can be different for each of the predetermined locations as further described below with respect to a second business method provided by the present disclosure.

The present disclosure also provides a cell phone or other mobile device capable of being programmed for displaying or otherwise providing an indication of the number of points awarded to the subscriber while communicating using his mobile device or receiving satellite radio signals via his mobile device. The cell phone and other mobile device can further be programmed to display or otherwise provide an indication of the number of points that are awarded for each time period (seconds, minutes, etc.) of usage time while at the present location.

As such, the system 10 provides for transmitting communication signals from a computing device 70 in operative communication with controller 26, which can also be the pico cell 12 or other routing computing device, in vicinity to the cell phone 16 or other mobile device 16a. The communication signals are processed by the cell phone or other mobile device for determining and displaying the number of points that are awarded for each time period of usage time while at the present location. As the number of points that are awarded for each time period of usage time increase and decrease from location to location, the mobile device subscribers will opt to select the locations where the most points are awarded for using their mobile devices for communication purposes or for receiving satellite reception signals.

As such, the method and system of the present disclosure provides a means for providing an incentive to subscribers for moving from one location to another when desiring to utilize usage time and to also patronize one business establishment over another based on the number of points awarded among different business establishments.

In accordance with the second business method of the present disclosure, the business establishments provide a fee to the operator of the system 10 in accordance with a predetermined amount of points to be awarded for usage or air time while at their locations. Two different business establishments or two different predetermined locations are associated with different mathematical formulas for computing a different number of points for identical mobile device usage times between the two different business establishments or the two different predetermined locations.

For example, a first business establishment which pays $100 per month to the operator would provide for the operator to program the controller 26 to award one point per hour of usage time for usage or air time while at the first business establishment's location; and a second business establishment which pays $200 per month to the operator would provide for the operator to program the controller 26 to award two points per hour of usage time for usage or air time while at the second business establishment's location.

The number of points awarded to a subscriber can be stored within the cell phone or other mobile device for easily determining by the subscriber the total number of points awarded during a predetermined time period. The number of points can also be stored within the mobile device separately for each communication session, such that the subscriber can easily determine how many points he was awarded during each communication session (e.g., cell phone call, wireless email transmission, Internet access, and satellite radio reception).

The cell phone and other mobile device can further be programmed for enabling the subscriber to redeem points by communicating with the controller 26 or a call center and redeeming points for at least one of service; product; travel-related discounts/promotions; giveaways, contests or sweepstakes; etc. The service can include a communication service, such that the subscriber can use his cell phone or other mobile device to obtain a discount on a communication service; and add a communication feature to his cell phone or other mobile device, such as three-way calling, Caller-ID, call forwarding, and conference calling.

The present technology can also be adapted by one skilled in the art to determine when a satellite radio subscriber has his satellite radio on and is listening to a satellite radio channel. In accordance with the present disclosure, the satellite radio transmits a unique signal to the controller 26 continuously while it is turned on and tuned to a channel. The unique signal includes a unique data string identifying the subscriber corresponding to the satellite radio. The unique data string can further include other information besides the identity of the subscriber, such as the channel the satellite radio is tuned to, channels the subscriber has programmed as pre-programmed channel settings, and the volume level. The satellite radio service provider or operator of the system 10 can then award frequent flyer mileage points or other types of points based on the satellite radio usage time during a predetermined period of time in accordance with the teachings of the present disclosure. The number of points awarded can be for example 0.10 point for every one hour of satellite radio usage time.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method in a wireless communication system providing communication services to a plurality of subscribers, the method comprising:
determining whether a mobile device subscriber is at a predetermined location;
determining amount of mobile device usage time by the mobile device subscriber of a mobile device while at the predetermined location; and
awarding points to the mobile device subscriber based at least on the amount of mobile device usage time of the mobile device while at the predetermined location.

2. The method according to claim 1, wherein the first determining step comprises:
appending a data string to signals transmitted by the mobile device while at the predetermined location; and
analyzing the signals to determine whether they contain the data string.

3. The method according to claim 1, wherein the points are redeemable for at least one of a service and product.

4. The method according to claim 1, wherein the points are frequent flyer mileage points, and further comprising adding the points to the mobile device subscriber's frequent flyer mileage point account.

5. The method according to claim 1, wherein the predetermined location is onboard a carrier transporting the mobile device subscriber from a first geographical location to a second geographical location.

6. The method according to claim 5, wherein the awarding points step further includes awarding points based on at least one of travel-related information corresponding to the carrier, subscriber-related information, and communication-related information, wherein the travel-related information is selected from the group consisting of: information relating to the first geographical location; information relating to the second geographical location; time of departure; time of arrival, whether destination is an international destination; whether majority of travel is during a particular time period; whether time of departure was delayed for more than a predetermined amount of time; whether non-stop to the destination; and whether a meal is served during duration of trip; wherein the subscriber-related information is selected from the group consisting of: travel status of the subscriber; number of passengers traveling with the subscriber; period of time subscriber is a customer of at least the service provider and carrier's owner and/or operator; and occupation of the subscriber; and wherein communication-related information is selected from the group consisting of: time of day of the communication service; length of time of the communication service; and type of communication service.

7. The method according to claim 5, further comprising paying a fee by a business establishment associated with the predetermined location or the operator of the carrier to at least one of an operator of the communication system and a service provider of the communication services.

8. The method according to claim 1, wherein the mobile device usage time is selected from the group consisting of cell phone usage time, Internet access usage time, satellite radio usage time, wireless email usage time, and messaging usage time.

9. The method according to claim 1, wherein the awarding step includes determining a mathematical formula associated with the predetermined location for computing the number of points to award to the mobile device subscriber based on the amount of mobile device usage time while at the predetermined location.

10. A wireless communication network comprising:
a database configured to store at least one point account;
a controller operatively coupled to the database, the controller comprising a memory and a processor operatively coupled to the memory,
the controller being programmed to determine usage of air time for communication services by a subscriber at predetermined locations;
the controller being programmed to award a number of points to the subscriber based on the usage of air time at the predetermined locations; and
the controller being programmed to store the number of points awarded to the subscriber in a point account associated with the subscriber.

11. The communication network according to claim 10, wherein the controller is programmed to award points for each usage of air time period according to a mathematical formula, and wherein the controller is programmed to award points according to at least two different mathematical formulas each respectively corresponding to at least two different predetermined locations.

12. The communication network according to claim 10, wherein the controller is programmed to award points for each usage of air time period according to a mathematical formula, and wherein the controller is programmed to award points according to at least two different mathematical formulas each respectively corresponding to at least two different communication services.

13. The communication network according to claim 10, further comprising a plurality of computing devices each positioned at each of the predetermined positions for appending an identification data string to communication signals transmitted to the controller, and wherein the controller is programmed to identify the identification data string and determine the predetermined location associated with the identified identification data string.

14. The communication network according to claim 10, further comprising a global positioning system in operative communication with the controller for relaying the position of the subscriber, the controller being programmed to determine whether the position of the subscriber is at one of the predetermined locations.

15. The communication network according to claim 10, wherein the predetermined locations include onboard a carrier transporting the mobile device subscriber from a first geographical location to a second geographical location.

16. The communication network according to claim 10, wherein the at least one point account is configured for storing usage time corresponding to at least two types of usage time.

17. The communication network according to claim 10, wherein the points are frequent flyer mileage points, and further comprising programming the controller to communicate the points to a database storing the mobile device subscriber's frequent flyer mileage point account.

18. A method in a wireless communication system providing communication services to a plurality of subscribers, the method comprising:
providing an incentive to each of the plurality of subscribes based on mobile device usage time while at one of a plurality of predetermined locations;
determining whether a mobile device subscriber is at the one of the plurality of predetermined locations;
determining amount of mobile device usage time by the mobile device subscriber of a mobile device while at the one of the plurality of predetermined locations;
determining a number points to award to the mobile device subscriber based on mobile device usage time at the one of the plurality of predetermined locations, wherein a different number of points are determined for identical mobile device usage times between at least two of the plurality of predetermined locations; and
awarding the number of points computed to the mobile device subscriber.

19. The method according to claim 18, wherein the points are frequent flyer mileage points, and further comprising adding the points to the mobile device subscriber's frequent flyer mileage point account.

20. The method according to claim 18, wherein the predetermined location is onboard a carrier transporting the mobile device subscriber from a first geographical location to a second geographical location.
